(19) United States
(12) Patent Application Publication
(10) Pub. No.: US 2026/0237125 A1
(43) Pub. Date: Aug. 13, 2026

(54) BACKGROUND IMAGE GENERATION METHOD, ELECTRONIC DEVICE, AND COMPUTER STORAGE MEDIUM

(71) Applicant: UC Mobile Co., Ltd., Beijing (CN)

(72) Inventors: Yi SHAN, Hangzhou (CN); Yuansheng LUO, Hangzhou (CN)

(21) Appl. No.: 19/638,302

(22) Filed: Apr. 3, 2026

Related U.S. Application Data
(63) Continuation of application No. PCT/CN2024/124811, filed on Oct. 14, 2024.

(30) Foreign Application Priority Data
Oct. 18, 2023 (CN) 202311355147.8

(51) Int. Cl. G06T 11/60; G06T 5/20; G06T 7/194

(52) U.S. Cl. CPC G06T 11/60; G06T 5/20; G06T 7/194; G06T 2207/20036; G06T 2207/20081

(57) ABSTRACT

The embodiments of the present application provide a background image generation method, electronic device, and storage medium. The background image generation method comprises: acquiring a real image generated based on a physical document; performing multiple different types of target content detection on the real image to obtain a corresponding plurality of target content image regions and a corresponding plurality of target content masks; fusing the plurality of target content masks to obtain a fused mask; erasing, from the real image, an image region corresponding to the fused mask, and obtaining a background image corresponding to the real image based on an erasure result.

### CROSS-REFERENCE TO RELATED APPLICATIONS

This application is a Continuation Application of International Patent Application No. PCT/CN2024/124811, filed on October 14, 2024, which is based on and claims priority to and benefits of Chinese Patent Application No. 202311355147.8, filed with the China National Intellectual Property Administration on October 18, 2023, and entitled “Background Image Generation Method, Electronic Device, and Computer Storage Medium.” The above-referenced applications are incorporated herein by reference in their entirety.

### TECHNICAL FIELD

The embodiments of the present application relate to the field of computer technology, and more particularly to a background image generation method, electronic device, and computer storage medium.

### BACKGROUND

With the development of computer technology, there are frequent needs for electronic scanned documents in people's daily lives and work, such as application scenarios including digitization of books, invoice reimbursement, scanning and printing of work documents, scanned copies of identification materials, and the like.

Since professional scanners are expensive, scanning software has emerged to meet the need. Through scanning software, users can achieve convenient, low-cost document scanning anytime and anywhere. With the widespread use of scanning software, scanning scenarios have become increasingly diversified, which requires scanning software to continuously undergo iterative updates to adapt to new scenario requirements. However, the iterative update of scanning software requires a large number of training samples from various scanning scenarios as a prerequisite. To this end, in one existing approach, professional rendering software (such as Unity3D, etc.) is used to construct a virtual lighting environment, which may include different light sources, different occluding objects, different texture backgrounds, etc., and by varying the position, intensity, and color temperature of light sources in combination with different occluding objects and paper textures to simulate the scenario of a user scanning a document, so as to make the background of the generated scanned image more realistic, thereby making the scanned image more lifelike. However, in this approach, first, such professional rendering software has a high barrier to use, requiring lengthy debugging and learning to achieve a certain simulation effect, with significant time costs, resulting in an overall high implementation cost; second, image backgrounds simulated and generated by such professional rendering software have a relatively large deviation in data distribution from a real sample distribution, causing the background effect of the generated scanned images to be poor, which in turn leads to a situation where the machine learning model implementing software scanning performs well on simulated training samples but performs poorly on real data.

### SUMMARY

In view of this, the embodiments of the present application provide a background image generation solution to at least partially address the above problems.

According to a first aspect of the embodiments of the present application, a background image generation method is provided, comprising: acquiring a real image generated based on a physical document; performing multiple different types of target content detection on the real image to obtain a corresponding plurality of target content image regions and a corresponding plurality of target content masks; fusing the plurality of target content masks to obtain a fused mask; erasing, from the real image, an image region corresponding to the fused mask, and obtaining a background image corresponding to the real image based on an erasure result.

According to a second aspect of the embodiments of the present application, there is provided an electronic device, comprising: a processor, a memory, a communications interface and a communication bus, where the processor, the memory and the communications interface complete mutual communication via the communication bus; the memory is configured to store at least one executable instruction, and the executable instruction causes the processor to perform operations corresponding to the method according to the first aspect.

According to a third aspect of the embodiments of the present application, a computer storage medium is provided, having a computer program stored thereon, which when executed by a processor, implements the method according to the first aspect.

According to yet another aspect of the embodiments of the present application, a computer program product is provided, comprising computer instructions that instruct a computing device to perform operations corresponding to the method according to the first aspect.

According to the solution provided by the embodiments of the present application, target content detection and mask processing can be performed on a real image containing document information, a fused mask can be generated based on a plurality of target content masks, and image region erasure can be performed based on the fused mask, thereby obtaining a background image corresponding to the real image. As a result, on one hand, there is no need for image processing personnel to perform complex parameter learning and debugging, and a corresponding background image can be generated based on the real image, thereby reducing the cost of background image generation; on the other hand, since the background image is generated based on the real image, its data distribution is consistent with a real sample distribution, which not only enables the generated scanned image to have a better background effect, but also enables better training results for machine learning models that implement software scanning when scanned document sample images are subsequently synthesized based on the background image as training samples.

### BRIEF DESCRIPTION OF THE DRAWINGS

In order to more clearly illustrate the technical solutions in the embodiments of the present application or in the prior art, the drawings required for use in the description of the embodiments or the prior art will be briefly introduced below. Obviously, the drawings described below are merely some of the embodiments recorded in the embodiments of the present application, and those of ordinary skill in the art may also obtain other drawings based on these drawings.

FIG. 1 is a schematic diagram of an exemplary system to which the solution of the embodiments of the present application is applicable.

FIG. 2 is a flowchart of steps of a background image generation method according to an embodiment of the present application.

FIG. 3 is a flowchart of an optional sub-step of step S104 of the present application.

FIG. 4 is a flowchart of an optional sub-step of step S106 of the present application.

FIG. 5 is a flowchart of an optional sub-step of step S108 of the present application.

FIG. 6 is a schematic diagram of a scenario example in an embodiment of the present application.

FIG. 7A is a schematic diagram of a scenario example of a synthesized scanned document sample image in an embodiment of the present application.

FIG. 7B is a schematic diagram of another scenario example of a synthesized scanned document sample image in an embodiment of the present application.

FIG. 8 is a structural schematic diagram of an electronic device according to an embodiment of the present application.

### DETAILED DESCRIPTION OF THE EMBODIMENTS

In order to enable those skilled in the art to better understand the technical solutions in the embodiments of the present application, the technical solutions in the embodiments of the present application will be described clearly and completely below with reference to the drawings in the embodiments of the present application. Obviously, the described embodiments are only some, not all, of the embodiments of the present application. All other embodiments obtained by those of ordinary skill in the art based on the embodiments of the present application shall fall within the scope of protection of the embodiments of the present application.

The specific implementation of the embodiments of the present application is further described below in conjunction with the drawings of the embodiments of the present application.

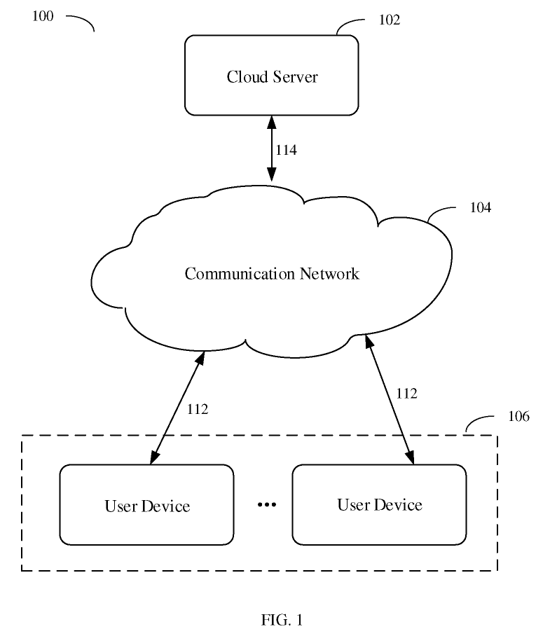

FIG. 1 illustrates an exemplary system applicable to the solution of the embodiments of the present application. As shown in FIG. 1, the system 100 may include a cloud server 102, a communication network 104, and/or one or more user devices 106, with multiple user devices shown as an example in FIG. 1. It should be noted that the solution of the embodiments of the present application may be completed collaboratively by the cloud server 102 and the user device 106, or may be completed independently by the user device 106.

The cloud server 102 may be any suitable device for storing information, data, programs, and/or any other suitable type of content, including but not limited to distributed storage system devices, server clusters, computing cloud server clusters, etc. In some embodiments, the cloud server 102 may perform any suitable function. For example, when the cloud server 102 and the user device 106 cooperate to implement the solution of the embodiments of the present application, in some embodiments, the cloud server 102 may receive a real image generated based on a physical document sent by the user device 106, and generate a background image corresponding to the real image. As an optional example, in some embodiments, the cloud server 102 may first perform multiple different types of target content detection on the real image to obtain a corresponding plurality of target content image regions and a corresponding plurality of target content masks; then, the plurality of target content masks may be fused to obtain a fused mask; and then, the image region corresponding to the fused mask is erased from the real image, and the background image corresponding to the real image is obtained based on the erasure result. As another example, in some optional embodiments, the cloud server 102 may send the generated background image to the user device 106. In some optional embodiments, the cloud server 102 may synthesize a scanned document sample image based on the background image (for example, synthesizing a scanned document sample image based on the background image and a preset document content image; or, synthesizing a scanned document sample image based on the background image and preset document content text), and train a machine learning model for generating scanned documents using the scanned document sample image as a training sample.

In some embodiments, the communication network 104 may be any suitable combination of one or more wired and/or wireless networks. For example, the communication network 104 may include any one or more of the following: the Internet, an intranet, a Wide Area Network (Wide Area Network, WAN), a Local Area Network (Local Area Network, LAN), a wireless network, a Digital Subscriber Line (Digital Subscriber Line, DSL) network, a frame relay network, an Asynchronous Transfer Mode (Asynchronous Transfer Mode, ATM) network, a Virtual Private Network (Virtual Private Network, VPN), and/or any other suitable communication network. The user device 106 may be connected to the communication network 104 via one or more communication links (e.g., communication link 112), and the communication network 104 may be linked to the cloud server 102 via one or more communication links (e.g., communication link 114). The communication links may be any communication links suitable for transferring data between the user device 106 and the cloud server 102, such as network links, dial-up links, wireless links, hardwired links, any other suitable communication links, or any suitable combination of such links.

The user device 106 may include any one or more user devices suitable for presenting images, interacting with users, and the like. When the scheme of the embodiments of the present application is independently completed by the user device 106, the user device 106 may be used to generate a background image corresponding to a real image based on the real image generated based on a physical document. As an optional example, in some embodiments, the user device 106 may first perform multiple different types of target content detection on the real image to obtain a corresponding plurality of target content image regions and a corresponding plurality of target content masks; then, the plurality of target content masks may be fused to obtain a fused mask; and then, from the real image, the image region corresponding to the fused mask may be erased, and a background image corresponding to the real image may be obtained based on the erasure result. In some optional embodiments, the user device 106 may synthesize a scanned document sample image based on the background image (for example, synthesizing a scanned document sample image based on the background image and a preset document content image; or, synthesizing a scanned document sample image based on the background image and preset document content text). Furthermore, the user device 106 may send the scanned document sample image to the cloud server 102 to train a machine learning model in the cloud server 102 for generating scanned documents. In some embodiments, the user device 106 may include any suitable type of device. For example, in some embodiments, the user device 106 may include a mobile device, a tablet computer, a laptop computer, a desktop computer, and/or any other suitable type of user device.

Based on the above system, the embodiments of the present application provide a background image generation solution, which is described below through multiple embodiments.

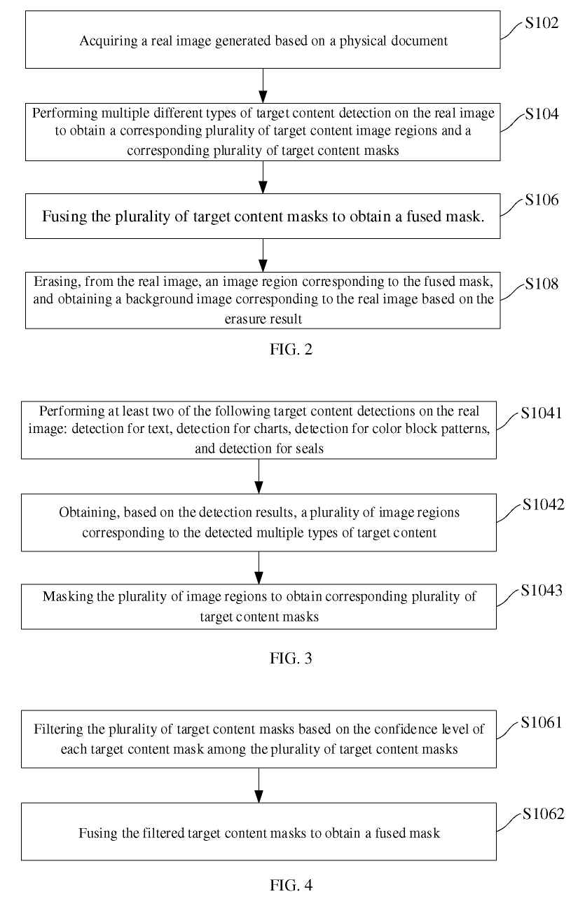

FIG. 2 is a flowchart of steps of a background image generation method according to an embodiment of the present application. According to a first aspect of the present application, a background image generation method is provided. Referring to FIG. 2, the method includes steps S102, S104, S106, and S108, specifically:

S102: acquiring a real image generated based on a physical document.

In the present application, a physical document may refer to a physical document for scanning. The physical document may be of any type; for example, the physical document includes but is not limited to books, invoices, contracts, business licenses, work documents, identification materials, ID cards, driver's licenses, and the like.

The real image in the present application has the characteristics of real samples, and its data distribution is consistent with that of real samples, which enables the background image generated based on the real image to have a data distribution consistent with that of a real sample distribution.

Optionally, the real image generated based on a physical document in step S102 of the present application may be an image obtained by capturing the physical document with a camera in advance. For example, taking a physical document that is an invoice as an example, the real image generated based on the invoice may be obtained in the following manner: the user places the invoice to be scanned on a support (such as a table surface, etc.) or holds it in hand, and then uses the camera on a mobile terminal to capture the invoice from a direction facing the invoice, thereby obtaining the corresponding real image. It should be understood that this is merely an example and does not constitute any limitation on the present application.

It should be understood that acquiring the real image generated based on a physical document in step S102 may involve capturing the real image when needed and then directly acquiring it, or capturing the real image in advance and then storing the real image in a predetermined storage space (including but not limited to storage media such as disks, hard disks, memories, etc., and may also be a database, etc.), and directly acquiring it from the storage space when needed. The present application does not impose any limitation on this.

Optionally, the real image may also include images with defects that have been processed by a model (for example, these images may be accumulated from images with defects processed by a machine learning model used by scanning software to implement software scanning, during the historical use of scanning software by users (which may include online users and/or offline users)), and the required real images may be manually selected from the images with defects processed by the model and stored in a storage space, or alternatively, the required real images may be retrieved from the images with defects processed by the model according to rules using an algorithm and then stored in the storage space. For example, defects may include, but are not limited to, targets such as shadows, creases, text bleed-through, fingers, and clips appearing in the image; these targets may serve as part of the background of the real image, belong to the characteristics of real samples, and are consistent with real samples in terms of data distribution. By generating background images from such real images and subsequently using the background images to synthesize scanned document sample images for training the machine learning model used to generate scanned documents, the capability boundaries of the machine learning model can be expanded.

S104: performing multiple different types of target content detection on the real image to obtain a corresponding plurality of target content image regions and a corresponding plurality of target content masks.

The real image generated based on a physical document acquired in step S102 contains multiple different types of target content. Such target content typically constitutes meaningful informational content. Therefore, in step S104 of the present application, multiple different types of target content detection may be performed on the real image to obtain a corresponding plurality of target content image regions and a corresponding plurality of target content masks, so that subsequent steps can utilize the plurality of target content masks for data processing to obtain a background image that better meets the requirements.

In the present application, the target content may be determined based on the corresponding real image. In some optional embodiments, the target content in the present application includes at least one of the following types: text-type content, chart-type content, color block pattern-type content, and seal-type content. Optionally, referring to the flowchart shown in FIG. 3, step S104 includes sub-steps S1041, S1042, and S1043, specifically:

S1041: performing at least two of the following target content detections on the real image: detection for text, detection for charts, detection for color block patterns, and detection for seals.

In the present application, any feasible target detection algorithm may be used to implement detection for text, charts, color block patterns, and seals.

In the present application, by performing at least two different types of target content detection among text, charts, color block patterns, and seals on the real image, the background image generation method of the present application can better adapt to the needs of document scanning in real life.

In addition, the present application does not specifically limit text, charts, color block patterns, and seals. For example, the following illustrative understanding may be referred to: text may include but is not limited to Chinese characters, Arabic numerals, English text, and the like; charts may include but are not limited to bar charts, pie charts, line charts, tables, and the like; color block patterns may include any regular or irregular color block patterns; seals may include but are not limited to regular-shaped seals such as circular seals and rectangular seals, and may also be seals of other shapes.

It should also be noted that although the present application performs at least two different types of target content detection among text, charts, color block patterns, and seals on the real image, this does not necessarily mean that multiple different types of target content will be detected from the real image. This depends on the actual conditions of the target image, and the present application does not impose any limitation on this. For example, if the real image contains only text-type content and no chart-type content, color block pattern-type content, seal-type content, or the like, then although multiple different types of target detection will be performed, the detection results may only contain results corresponding to text-type content. Of course, this is merely an example and does not constitute any limitation on the present application.

In addition, it should also be noted that in the present application, "multiple," "plurality," and other quantities related to "multiple" mean two or more.

S1042: obtaining, based on the detection results, a plurality of image regions corresponding to the detected multiple types of target content.

Specifically, based on the detection results of the target content detection obtained in sub-step S1041, a plurality of image regions corresponding to multiple types of detected target content may be determined from the real image, and these image regions include at least part of the content other than the background in the real image.

Since sub-step S1041 performs target content detection of at least two different types among text, charts, color block patterns, and seals on the real image, after the corresponding content is detected, appropriate processing may be performed on it to obtain the corresponding image regions. For example, in some optional embodiments, sub-step S1042 includes at least one of the following sub-steps S1042A, S1042B, S1042C, and S1042D, specifically:

S1042A: if, based on the detection results, it is determined that text-type content has been detected, text recognition is performed on the text-type content to determine, based on the text recognition results, the image regions corresponding to each individual character.

Optionally, any suitable text recognition algorithm may be used to recognize the text-type content to determine, based on the text recognition results, the image regions corresponding to each individual character. For example, text recognition algorithms include, but are not limited to, OCR (Optical Character Recognition) algorithms and the like.

S1042B: if, based on the detection results, it is determined that chart-type content has been detected, image segmentation is performed on the chart-type content to obtain the image region corresponding to the chart-type content.

Optionally, any suitable image segmentation algorithm may be used to perform image segmentation on the chart-type content to obtain the image region corresponding to the chart-type content. For example, image segmentation algorithms include, but are not limited to, semantic segmentation algorithms, instance segmentation algorithms, and the like.

S1042C: if, based on the detection results, it is determined that color block pattern-type content has been detected, image segmentation is performed on the color block pattern-type content to obtain the image region corresponding to the color block pattern content.

Optionally, any suitable image segmentation algorithm may be used to perform image segmentation on the color block pattern-type content to obtain the image region corresponding to the color block pattern-type content. For example, image segmentation algorithms include, but are not limited to, semantic segmentation algorithms, instance segmentation algorithms, and the like.

S1042D: if, based on the detection results, it is determined that seal-type content has been detected, text recognition and border recognition are performed on the seal-type content to determine, based on the recognition results, the image region corresponding to the seal.

Optionally, any suitable text recognition algorithm and any suitable border recognition algorithm may be used to recognize the seal-type content to obtain the image region corresponding to the seal-type content. For example, the text recognition algorithm used includes, but is not limited to, OCR (Optical Character Recognition) algorithms and the like.

Based on this, through the optional implementations of sub-steps S1042A to S1042D in the present application, for the different target content determined based on the detection results, different approaches are used to adaptively determine the image regions corresponding to the target content, thereby enabling accurate and effective determination results for the image regions to be obtained.

S1043: masking the plurality of image regions to obtain corresponding plurality of target content masks.

After the plurality of target regions are obtained in sub-step S1042, mask processing may be performed on the plurality of image regions to obtain the corresponding plurality of target content masks. The specific manner of obtaining the masks may be implemented by those skilled in the art using any suitable approach, including but not limited to approaches in which the masks are obtained through a machine learning model used to mask target objects in an image. In addition, optionally, when the machine learning model outputs the masks corresponding to the image regions, it may also simultaneously output the confidence level of each mask.

Based on this, through the optional implementations of sub-steps S1041 to S1043 described above in the present application, multiple different types of target content detection may be accurately and effectively performed on the real image to obtain the corresponding plurality of target content image regions and the corresponding plurality of target content masks, thereby facilitating subsequent data processing using them to obtain a background image that better meets the requirements.

S106: fusing the plurality of target content masks to obtain a fused mask.

After the plurality of target content masks are obtained, the plurality of target content masks are fused (e.g., fused by means of merging, etc.) to obtain a fused mask that better meets data processing requirements. Through the fused mask, on one hand, the effect of generating the background image in subsequent steps can be better improved, and on the other hand, the amount of computation when subsequently generating the background image can also be conveniently reduced.

The present application does not limit the specific implementation of step S106, as long as it can meet the requirements. In some optional embodiments, referring to the flowchart shown in FIG. 4, step S106 includes sub-steps S1061 and S1062, specifically:

S1061: filtering the plurality of target content masks based on the confidence level of each target content mask among the plurality of target content masks.

For example, as mentioned above, when the machine learning model outputs the masks corresponding to the image regions, it may also output the confidence level corresponding to each mask. In this step, based on the confidence level of each target content mask among the plurality of target content masks, target content masks with lower confidence level may be filtered out to ensure the accuracy of the target content masks.

The present application does not limit the specific implementation of sub-step S1061. In some optional embodiments, filtering may be performed by setting a confidence level threshold. For example, sub-step S1061 may specifically be implemented by determining whether the confidence level of each target content mask among the plurality of target content masks is greater than the confidence level threshold: if so, the mask is retained; if not, the mask is not retained, thereby achieving the purpose of filtering the plurality of target content masks. The confidence level threshold may be set as needed, for example, it may be set to 70%, 80%, and so on.

Alternatively, sub-step S1061 may also filter based on other conditions as needed, which is not specifically limited herein.

S1062: fusing the filtered target content masks to obtain a fused mask.

Illustratively, the target content masks may be fused by methods such as mask merging.

Based on this, through the optional implementations of sub-steps S1061 to S1062 described above, the present application can effectively fuse multiple target content masks to obtain a fused mask. On one hand, fusing multiple target content masks into a whole can facilitate subsequent processing, such as erasure processing, thereby improving processing speed; on the other hand, it can also better avoid erasing too many background regions in the real image when subsequently erasing the image region corresponding to the fused mask, thereby better improving the effect of generating a background image in subsequent steps and reducing the computational load when subsequently generating the background image.

S108: erasing, from the real image, the image region corresponding to the fused mask, and obtaining a background image corresponding to the real image based on the erasure result.

After the fused mask is obtained in step S106, the image region corresponding to the fused mask may be erased from the real image, so that only the background remains in the erased real image, and accordingly a background image corresponding to the real image can be obtained based on the erasure result.

Based on this, through the background image generation method of steps S102 to S108 described above, the present application can perform target content detection and mask processing on a real image containing document information, generate a fused mask based on multiple target content masks, and perform image region erasure based on the fused mask, thereby obtaining a background image corresponding to the real image. As a result, on one hand, image processing personnel do not need to perform complex parameter learning and debugging, and the corresponding background image can be generated based on the real image, reducing the cost of background image generation; on the other hand, since the background image is generated based on the real image, it is consistent with the real sample data distribution in terms of data distribution, which not only enables the background effect of the generated scanned image to be better, but also, when subsequently synthesizing scanned images based on the background image as training samples, enables the training effect of the machine learning model implementing software scanning to be better as well.

In the present application, the specific implementation of step S108 is not limited, as long as the corresponding requirements can be met. For example, when implementing step S108 and its various optional implementations, the content of the image region corresponding to the fused mask may be erased from the real image to obtain an erasure result, and the erased region may be filled with content from neighboring regions, so as to obtain a background image corresponding to the real image based on the erasure result. For example, the erasure may be implemented using methods including but not limited to traditional image inpainting techniques and artificial intelligence (AI)-based image inpainting techniques, or may be implemented in other ways, and the present application does not impose any limitation thereon.

In some optional embodiments, after the fused mask is obtained in step S106, the background image generation method further comprises: performing morphological processing on the fused mask according to morphological processing parameters; and "erasing, from the real image, the image region corresponding to the fused mask" in step S108 comprises: erasing, from the real image, the image region corresponding to the morphologically processed fused mask.

Optionally, by performing morphological processing on the fused mask and erasing the morphologically processed fused mask from the real image, the effect of obtaining the background image corresponding to the real image based on such an erasure result is better.

Optionally, performing morphological processing on the fused mask may include at least one of erosion processing and dilation processing. Different morphological parameters may be used to perform different types of morphological processing according to the needs of different real images, and no particular limitation is imposed thereon in the present application.

In some optional embodiments, referring to the flowchart shown in FIG. 5, step S108 comprises sub-steps S1081 and S1082, specifically:

S1081: erasing, from the real image, the image region corresponding to the fused mask, to obtain an after-erasure image;

S1082: calculating the information entropy of the after-erasure image; if the information entropy satisfies the preset information entropy threshold, using the after-erasure image as the background image corresponding to the real image.

Specifically, in sub-step S1082, information entropy may be used to represent the richness of content in an image; a higher value of information entropy indicates a higher amount of information and richer content, and conversely, less content. Accordingly, it is possible to determine whether the image region corresponding to the fused mask in the real image has been cleanly erased by calculating the information entropy of the after-erasure image.

In the present application, the preset information entropy threshold may be used to determine whether the information entropy of the after-erasure image meets the requirement. If the information entropy of the after-erasure image satisfies the preset information entropy threshold, it may be considered that the image region corresponding to the fused mask in the real image has been cleanly erased, and the after-erasure image may be used as the background image corresponding to the real image.

Optionally, if the information entropy of the after-erasure image is lower than the preset information entropy threshold, then the information entropy of the after-erasure image satisfies the preset information entropy threshold; conversely, if the information entropy of the after-erasure image is higher than the preset information entropy threshold, then the information entropy of the after-erasure image does not satisfy the preset information entropy threshold. When the information entropy of the after-erasure image satisfies the preset information entropy threshold, the after-erasure image may be used as the background image corresponding to the real image.

Based on this, through the optional implementations of sub-steps S1081 to S1082, the present application can ensure that the image region corresponding to the fused mask in the real image is cleanly erased, and the after-erasure image obtained from the clean erasure is used as the background image of the real image, which can make the background effect of the generated scanned image better, and when subsequently synthesizing scanned images based on the background image as training samples, can also make the training effect of the machine learning model implementing software scanning better.

In the present application, the preset information entropy threshold may be set according to actual needs. In some optional embodiments, the preset information entropy threshold is determined in the following manner: determining a preset number of historical images similar to the real image currently being processed, and determining the preset information entropy threshold based on the minimum value among the information entropy values of the background images corresponding to the historical images. In this way, the preset information entropy threshold can be determined more reasonably, such that the result of determining whether the information entropy of the after-erasure image satisfies the preset information entropy threshold is more reasonable.

Specifically, historical images are real images from history, differing from the real image currently being processed only in terms of time. Optionally, in the present application, a historical image being similar to the real image currently being processed may mean that the historical image is similar in at least one of type and content layout. For example, if the type of the historical image is a real image generated based on an invoice, and the real image currently being processed is also a real image generated based on an invoice, then the two are considered similar; for another example, if the type of the historical image is a real image generated based on a business license, and the real image currently being processed is also a real image generated based on a business license, then the two are considered similar; for yet another example, if the historical image is a real image generated based on a page of a book having text-type content and chart-type content, and the real image currently being processed is a real image generated based on a page of a contract having text-type content and chart-type content, then the two are also considered similar. It should be understood that these examples are provided merely for ease of understanding and do not constitute any limitation on the present application. In addition, the preset number may be selected as needed, subject to being able to meet the requirements.

To provide an example for ease of understanding: assume the preset number is 100, then 100 historical images similar to the real image currently being processed can be identified, the content other than the background in each of the 100 historical images is erased, and the value of information entropy corresponding to each is calculated, yielding values of information entropy; the minimum value of information entropy is determined from the 100 values of information entropy and used as the preset information entropy threshold. It should be understood that this example is merely provided for ease of understanding and does not constitute any limitation on the present application.

In some optional embodiments, if the information entropy of the after-erasure image does not satisfy the preset information entropy threshold, the morphological processing parameter is adjusted to perform morphological processing on the fused mask, and the fused mask after morphological processing is used to return to the step in step S108 of "erasing the image region corresponding to the fused mask from the real image" for re-execution.

Specifically, when the information entropy of the after-erasure image does not satisfy the preset information entropy threshold, the morphological processing parameter is adjusted to perform morphological processing on the fused mask, and the fused mask after morphological processing is used so that the process returns to erasing the image region corresponding to the fused mask from the real image for re-execution, thereby facilitating the adjustment of the information entropy of the after-erasure image that does not satisfy the preset information entropy threshold until it satisfies the preset information entropy threshold, so as to ensure that the image region corresponding to the fused mask in the real image is cleanly erased, and the after-erasure image obtained by clean erasure is used as the background image of the real image, which can make the background effect of the generated scanned image better, and when subsequently synthesizing a scanned image based on the background image as a training sample, can also make the training effect of the machine learning model for implementing software scanning better.

FIG. 6 is a schematic diagram of a scenario example in an embodiment of the present application. Referring again to FIG. 6 for an overall understanding of the background image generation method of the present application, FIG. 6 illustrates a real image generated based on a physical document (as shown in the left-side interface in FIG. 6), where the real image includes text-type content, chart-type content, color block pattern-type content, and seal-type content; after the background image generation method of the present application is applied, the resulting output background image (as shown in the right-side interface in FIG. 6) has the aforementioned text-type content, chart-type content, color block pattern-type content, and seal-type content erased. It should be understood that the example in FIG. 6 does not constitute any limitation on the present application.

In some optional embodiments, the background image generation method further comprises: synthesizing a scanned document sample image based on the background image and a preset document content image. By this approach, the present application can effectively synthesize scanned document sample images for use.

Specifically, the preset document content image may be an existing image capable of representing document content. The preset document content image may also include an image representing document content that is segmented from an image (the image referred to here may include, but is not limited to, a real image). For example, the document content may include at least one of text content, chart content, color block pattern content, seal content, and the like. After being segmented, the preset document content image may be stored in a suitable storage space so that it can be retrieved when needed. Optionally, the preset document content image may have a solid-color background or a transparent background, which makes it more convenient to composite with the background image generated in step S108 to obtain the scanned document sample image. In one optional approach, the aforementioned solid-color background may be a white background, which is closer to the actual scanned document background and is also easier to process for compositing.

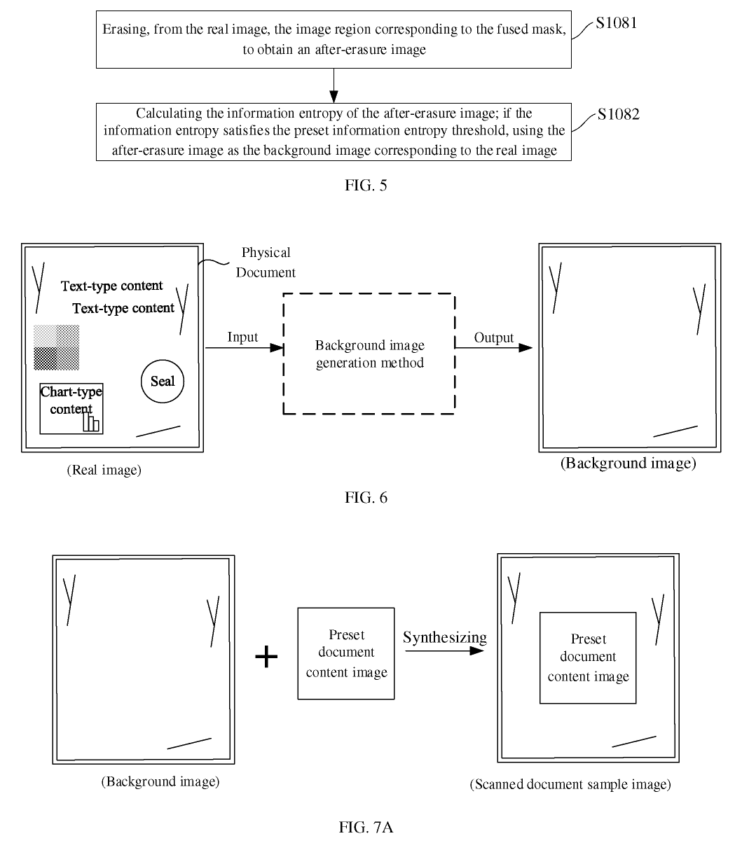

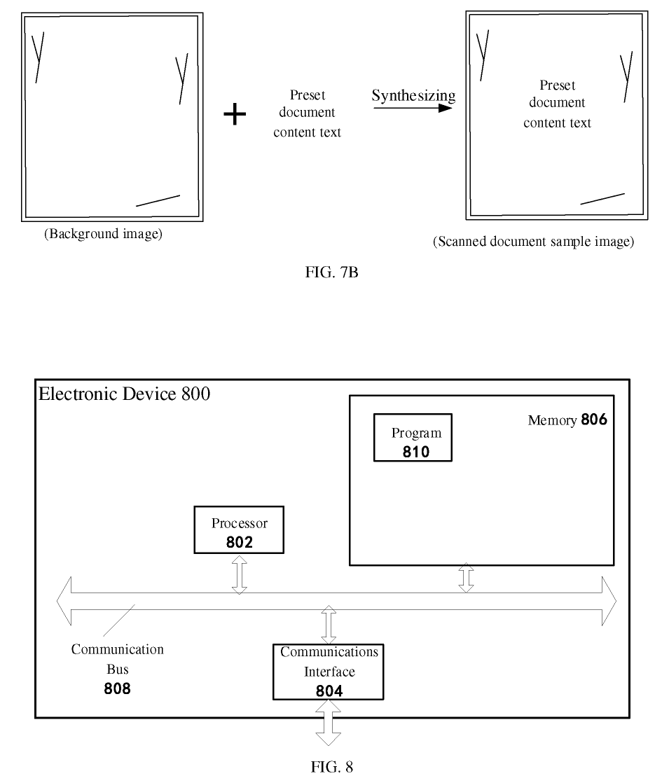

Referring to the scenario example shown in FIG. 7A for understanding, it illustrates an exemplary process of synthesizing a scanned document sample image based on the background image and a preset document content image; it should be understood that the example shown in FIG. 7A does not constitute any limitation on the embodiments of the present application.

Optionally, the scanned document sample image may be synthesized by overlaying or pasting the preset document content image onto a suitable area of the background image.

Or, in some other optional embodiments, the background image generation method further comprises: synthesizing a scanned document sample image based on the background image and preset document content text. By this approach, the present application can likewise effectively synthesize scanned document sample images for use.

Specifically, the preset document content text may be text content generated as needed. It should be noted that the document content text differs from the aforementioned document content image in that the document content image is an existing image, whereas the document content text is generated as needed. As an example, if a user wishes the center area of the scanned document sample image to include the word "Invoice," the user may input the text content of the word "Invoice" through software, adjust the appropriate text format (e.g., font, font size, etc.), and move such "Invoice" text content to the center area of the background image either manually or automatically, thereby synthesizing a scanned document sample image that meets the requirements based on the background image and the preset document content text. It should be understood that this example does not constitute any limitation on the present application.

Referring to the scenario example shown in FIG. 7B for understanding, it illustrates an exemplary process of synthesizing a scanned document sample image based on the background image and preset document content text; it should be understood that the example shown in FIG. 7B does not constitute any limitation on the embodiments of the present application.

In some optional embodiments, the background image generation method further comprises: training a machine learning model for generating scanned documents based on the scanned document sample image.

Using the scanned document sample images obtained by the technical solution of the present application as training samples, the background images of the training samples are generated based on real images and are therefore consistent with the real sample data distribution in terms of data distribution; thus the background effect of the training samples is good, and the training effect of the machine learning model for generating scanned documents can be made better; in addition, since the technical solution of the present application enables efficient generation of background images and scanned document sample images (i.e., training samples), it also facilitates rapid and targeted iteration of the machine learning model.

In summary, the solution provided in the embodiments of the present application can perform target content detection and mask processing on a real image containing document information, generate a fused mask based on multiple target content masks, and erase an image region based on the fused mask, thereby obtaining a background image corresponding to the real image. As a result, on one hand, image processing personnel are not required to perform complex parameter learning and debugging, and a corresponding background image can be generated directly from a real image, reducing the cost of background image generation; on the other hand, since the background image is generated based on the real image, it is consistent with the real sample data distribution in terms of data distribution, which not only enables the generated scanned image to have a better background effect, but also, when subsequently synthesizing a scanned image based on the background image as a training sample, enables the machine learning model for implementing software scanning to achieve a better training effect.

It can be understood that the foregoing description of the background image generation method is provided merely as some exemplary illustrations of the present application and does not constitute any limitation on the present application.

According to a second aspect of the embodiments of the present application, there is provided an electronic device, comprising: a processor, a memory, a communications interface and a communication bus, where the processor, the memory and the communications interface complete mutual communication via the communication bus; the memory is configured to store at least one executable instruction, and the executable instruction causes the processor to perform operations corresponding to the method according to the first aspect. Referring to FIG. 8, there is shown a structural schematic diagram of an electronic device according to an embodiment of the present application, and the specific embodiments of the present application do not limit the specific implementation of the electronic device.

As shown in FIG. 8, the electronic device 800 may include: a processor 802, a communications interface 804, a memory 806, and a communication bus 808.

The processor 802, the communications interface 804, and the memory 806 communicate with each other via the communication bus 808.

The communications interface 804 is configured for communicating with other electronic devices or servers.

The processor 802 is configured to execute the program 810, and specifically may execute the relevant steps in the embodiments of the background image generation method described above.

Specifically, the program 810 may include program code, and the program code includes computer operation instructions.

The processor 802 may be a CPU, or a GPU (Graphic Processing Unit), or an application specific integrated circuit ASIC (Application Specific Integrated Circuit), or one or more integrated circuits configured to implement the embodiments of the present application. The one or more processors included in the smart device may be the same type of processor, such as one or more CPUs, or may be different types of processors, such as one or more CPUs and one or more ASICs.

The memory 806 is configured to store the program 810. The memory 806 may include a high-speed RAM memory and may also include a non-volatile memory, such as at least one disk memory.

The program 810 may include a plurality of computer instructions, and the program 810 may specifically through the plurality of computer instructions cause the processor 802 to execute the operations corresponding to the background image generation method described in any one of the foregoing method embodiments.

For specific implementation of each step in program 810, reference may be made to the corresponding descriptions of the corresponding steps and units in the foregoing method embodiments, and the corresponding beneficial effects are provided, which will not be repeated here. Those skilled in the art can clearly understand that, for the convenience and brevity of description, the specific working processes of the devices and modules described above may be referred to the corresponding process descriptions in the foregoing method embodiments, and will not be repeated here.

According to the third aspect of the embodiments of the present application, the embodiments of the present application further provide a computer storage medium having a computer program stored thereon, where the program, when executed by a processor, implements the method described in any one of the foregoing plurality of method embodiments. The computer storage medium includes, but is not limited to: a Compact Disc Read-Only Memory (CD-ROM), a Random Access Memory (RAM), a floppy disk, a hard disk, or a magneto-optical disk.

The embodiments of the present application further provide a computer program product, comprising computer instructions that instruct a computing device to perform operations corresponding to any one of the background image generation methods in the foregoing plurality of method embodiments.

The electronic device 800/computer storage medium/computer program product embodiments in the embodiments of the present application have been described in detail in the foregoing background image generation method embodiments, and therefore the relevant content and beneficial effects may be understood with reference to the foregoing method embodiments and will not be repeated here.

In addition, it should be noted that the user-related information (including but not limited to user device information, user personal information, etc.) and data (including but not limited to sample data used for training models, data used for analysis, stored data, displayed data, etc.) involved in the embodiments of the present application are information and data that have been authorized by the user or fully authorized by all parties, and the collection, use, and processing of relevant data must comply with the relevant laws, regulations, and standards of the relevant countries and regions, and corresponding operation entries are provided for users to choose to authorize or refuse.

It should be noted that, according to implementation needs, each component/step described in the embodiments of the present application may be split into more components/steps, or two or more components/steps or partial operations of components/steps may be combined into new components/steps, in order to achieve the purpose of the embodiments of the present application.

The methods described above according to the embodiments of the present application may be implemented in hardware or firmware, or may be implemented as software or computer code storable in a recording medium (such as a CD-ROM, RAM, floppy disk, hard disk, or magneto-optical disk), or may be implemented as computer code originally stored in a remote recording medium or a non-transitory machine-readable medium and to be stored in a local recording medium, downloaded via a network, so that the methods described herein may be stored on such software processing on a recording medium using a general-purpose computer, a special-purpose processor, or programmable or special-purpose hardware such as an Application Specific Integrated Circuit ((Application Specific Integrated Circuit, ASIC) or a Field Programmable Gate Array ((Field Programmable Gate Array, FPGA)). It will be understood that a computer, processor, microprocessor controller, or programmable hardware includes storage components (e.g., Random Access Memory ((Random Access Memory, RAM), Read-Only Memory ((Read-Only Memory, ROM), flash memory, etc.) capable of storing or receiving software or computer code, and when the software or computer code is accessed and executed by the computer, processor, or hardware, the methods described herein are implemented. Furthermore, when a general-purpose computer accesses code for implementing the methods shown herein, execution of the code transforms the general-purpose computer into a special-purpose computer for executing the methods shown herein.

Those of ordinary skill in the art may appreciate that the units and method steps of the various examples described in connection with the embodiments disclosed herein may be implemented in electronic hardware, or a combination of computer software and electronic hardware. Whether these functions are performed in hardware or software depends on the specific application and design constraints of the technical solution. Skilled artisans may use different methods for specific applications to implement the described functions, but such implementation should not be considered as going beyond the scope of the embodiments of the present application.

The above embodiments are only used to illustrate the embodiments of the present application, and are not intended to limit the embodiments of the present application. Those of ordinary skill in the relevant technical field may make various changes and modifications without departing from the spirit and scope of the embodiments of the present application. Therefore, all equivalent technical solutions also fall within the scope of the embodiments of the present application, and the patent protection scope of the embodiments of the present application shall be defined by the claims.

1. A background image generation method, comprising:
acquiring a real image generated based on a physical document;
performing multiple different types of target content detection on the real image to obtain a corresponding plurality of target content image regions and a corresponding plurality of target content masks;
fusing the plurality of target content masks to obtain a fused mask;
erasing, from the real image, an image region corresponding to the fused mask, and obtaining a background image corresponding to the real image based on an erasure result.

2. The method of claim 1, wherein the fusing the plurality of target content masks to obtain a fused mask comprises:
filtering the plurality of target content masks according to a confidence level of each target content mask among the plurality of target content masks;
fusing the filtered target content masks to obtain a fused mask.

3. The method of claim 2, wherein
after the fused mask is obtained, the method further comprises: performing morphological processing on the fused mask according to a morphological processing parameter;
the erasing, from the real image, the image region corresponding to the fused mask comprises: erasing, from the real image, the image region corresponding to the fused mask that has undergone morphological processing.

4. The method of claim 1, wherein the erasing, from the real image, the image region corresponding to the fused mask, and obtaining the background image corresponding to the real image based on an erasure result comprises:
erasing, from the real image, the image region corresponding to the fused mask to obtain an after-erasure image;
calculating an information entropy of the after-erasure image, and if the information entropy satisfies a preset information entropy threshold, using the after-erasure image as the background image corresponding to the real image.

5. The method of claim 4, wherein the method further comprises:
if the information entropy does not satisfy the preset information entropy threshold, adjusting the morphological processing parameter to perform morphological processing on the fused mask, and using the fused mask after morphological processing is completed, returning to and re-executing the step of erasing, from the real image, the image region corresponding to the fused mask.

6. The method of claim 4, wherein the preset information entropy threshold is determined in the following manner:
determining a preset number of historical images similar to the real image currently being processed, and determining the preset information entropy threshold based on a minimum value among information entropy values of background images corresponding to the historical images.

7. The method of claim 1, wherein the target content includes at least one of the following types: text-type content, chart-type content, color block pattern-type content, seal-type content;
the performing multiple different types of target content detection on the real image to obtain a corresponding plurality of target content image regions and a corresponding plurality of target content masks, comprises:
performing at least two of the following target content detections on the real image: detection for text, detection for charts, detection for color block patterns, detection for seals;
obtaining, according to detection results, a plurality of image regions corresponding to the detected multiple types of target content;
masking the plurality of image regions to obtain a corresponding plurality of target content masks.

8. The method of claim 7, wherein the obtaining, according to the detection results, a plurality of image regions corresponding to multiple types of detected target content comprises at least one of the following:
if, according to the detection results, it is determined that text-type content is detected, performing text recognition on the text-type content to determine, according to a text recognition result, image regions corresponding to each piece of text respectively;
if, according to the detection results, it is determined that chart-type content is detected, performing image segmentation on the chart-type content to obtain an image region corresponding to the chart-type content;
if, according to the detection results, it is determined that color block pattern-type content is detected, performing image segmentation on the color block pattern-type content to obtain an image region corresponding to the color block pattern content;
if, according to the detection results, it is determined that seal-type content is detected, performing text recognition and border recognition on the seal-type content to determine, according to a recognition result, an image region corresponding to the seal.

9. The method of claim 1, further comprising:
synthesizing a scanned document sample image based on the background image and a preset document content image.

10. The method of claim 9, wherein the method further comprises:
training a machine learning model for generating scanned documents based on the scanned document sample image.

11. The method of claim 1, further comprising:
synthesizing a scanned document sample image based on the background image and preset document content text.

12. The method of claim 11, wherein the method further comprises:
training a machine learning model for generating scanned documents based on the scanned document sample image.

13. A non-transitory computer-readable storage medium configured with instructions executable by one or more processors to cause the one or more processors to perform operations comprising:
acquiring a real image generated based on a physical document;
performing multiple different types of target content detection on the real image to obtain a corresponding plurality of target content image regions and a corresponding plurality of target content masks;
fusing the plurality of target content masks to obtain a fused mask;
erasing, from the real image, an image region corresponding to the fused mask, and obtaining a background image corresponding to the real image based on an erasure result.

14. The non-transitory computer-readable storage medium of claim 13, wherein the fusing the plurality of target content masks to obtain a fused mask comprises:
filtering the plurality of target content masks according to a confidence level of each target content mask among the plurality of target content masks;
fusing the filtered target content masks to obtain a fused mask.

15. The non-transitory computer-readable storage medium of claim 14, wherein the operations further comprise:
after the fused mask is obtained, performing morphological processing on the fused mask according to a morphological processing parameter;
the erasing, from the real image, the image region corresponding to the fused mask comprises: erasing, from the real image, the image region corresponding to the fused mask that has undergone morphological processing.

16. The non-transitory computer-readable storage medium of claim 13, wherein the erasing, from the real image, the image region corresponding to the fused mask, and obtaining the background image corresponding to the real image based on an erasure result comprises:
erasing, from the real image, the image region corresponding to the fused mask to obtain an after-erasure image;
calculating an information entropy of the after-erasure image, and if the information entropy satisfies a preset information entropy threshold, using the after-erasure image as the background image corresponding to the real image.

17. The non-transitory computer-readable storage medium of claim 16, wherein the operations further comprise:
if the information entropy does not satisfy the preset information entropy threshold, adjusting the morphological processing parameter to perform morphological processing on the fused mask, and using the fused mask after morphological processing is completed, returning to and re-executing the step of erasing, from the real image, the image region corresponding to the fused mask.

18. The non-transitory computer-readable storage medium of claim 16, wherein the preset information entropy threshold is determined in the following manner:
determining a preset number of historical images similar to the real image currently being processed, and determining the preset information entropy threshold based on a minimum value among information entropy values of background images corresponding to the historical images.

19. The non-transitory computer-readable storage medium of claim 13, wherein the target content includes at least one of the following types: text-type content, chart-type content, color block pattern-type content, seal-type content;
the performing multiple different types of target content detection on the real image to obtain a corresponding plurality of target content image regions and a corresponding plurality of target content masks, comprises:
performing at least two of the following target content detections on the real image: detection for text, detection for charts, detection for color block patterns, detection for seals;
obtaining, according to detection results, a plurality of image regions corresponding to the detected multiple types of target content;
masking the plurality of image regions to obtain a corresponding plurality of target content masks.

20. An electronic device comprising:
one or more processors; and
one or more computer-readable memories coupled to the one or more processors and having instructions stored thereon that are executable by the one or more processors to perform one or more operations comprising:
acquiring a real image generated based on a physical document;
performing multiple different types of target content detection on the real image to obtain a corresponding plurality of target content image regions and a corresponding plurality of target content masks;
fusing the plurality of target content masks to obtain a fused mask;
erasing, from the real image, an image region corresponding to the fused mask, and obtaining a background image corresponding to the real image based on an erasure result.
